(19) United States
(12) Patent Application Publication
(10) Pub. No.: US 2013/0194107 A1
(43) Pub. Date: Aug. 1, 2013

(54) SOUND FIELD CONTROL APPARATUS AND PROGRAM

(71) Applicant: Denso Corporation, Kariya-city (JP)

(72) Inventor: Takashi Nagata, Nagoya-city (JP)

(73) Assignee: DENSO CORPORATION, Kariya-city (JP)

(21) Appl. No.: 13/750,171

(22) Filed: Jan. 25, 2013

(30) Foreign Application Priority Data
Jan. 27, 2012 (JP) 2012-015720

(51) Int. Cl. G08G 1/16

(52) U.S. Cl. CPC G08G 1/161
USPC 340/904

(57) ABSTRACT

A sound field control apparatus is disclosed. The apparatus includes a storage device for storing HRTFs in association with head shapes, a recognition device for recognizing a head shape of a target person with a head shape detection device, a HRTF selection device for selecting the HRTF corresponding to the recognized head shape from the stored HRTFs, a signal processor for obtaining a virtual sound source acoustic signal based on the selected head-related transfer function, and a notification sound output control device for controlling a notification sound output device by using the virtual sound source acoustic signal so that the target person hears the notification sound from a predetermined virtual sound source.

### CROSS REFERENCE TO RELATED APPLICATION

The present application is based on Japanese Patent Application No. 2012-15720 filed on Jan. 27, 2012, disclosure of which is incorporated herein by reference.

### TECHNICAL FIELD

The present disclosure relates to a sound field control apparatus and a program for, by using a virtual sound source, generating a notification sound for, for example, warning an occupant in a vehicle compartment about an obstacle.

### BACKGROUND

A technology for notifying a driver of abnormality such as a door left ajar during vehicle driving is known. In this technology, in order for the driver to easily detect a warned abnormal location (alarm location), a virtual sound source is provided at the alarm location.

Patent document 1 proposes a sound field control apparatus that can instantly and effectively notify a driver of an alarm-sound-related location or an obstacle position around the vehicle.

This technology moves the localization position of a virtual sound source so that the alarm sound for notifying the presence of an obstacle is moved in (or near) an attention-paying direction, for example.

Patent Document 1: JP 2006-5868A (US 2005/0280519A)

Like the above technology, a technology for localizing the virtual sound source by a stereo dipole or the like uses a head-related transfer function (HRTF) representing acoustic propagation characteristics up to each of right and left ears in each direction of the virtual sound source. The HRTF uses different coefficients (filter coefficients) for different head shapes. Therefore, if the driver mismatches the HRTF, audio image cannot be localized at an intended position.

Because of the above, it is necessary to manually adjust HRTFs to drivers on a driver-by-driver basis. This is a bothered work. For example, once a driver is changed, the HRTF does not match a new driver. Therefore, each time the driver is changed, it is necessary to manually select and adjust HRTF and adjustment and it is necessary to check whether an audio image localization etc. is appropriate.

### SUMMARY

The present disclosure has been made in view of the foregoing. It is therefore an object of the present disclosure to provide a sound field control apparatus and a program that can easily localize a virtual sound source at an intended position without requiring a driver to manually select and adjust an HRTF.

According to an example of the present disclosure, a sound field control apparatus comprises a virtual acoustic signal processing device, an notification sound output control device, a head-related transfer function storage device, a head shape recognition device, a head shape recognition device, and a head-related transfer function selection device. The virtual acoustic signal processing device obtains a virtual sound source acoustic signal by performing an operation using an acoustic data of a notification sound and a head-related transfer function. The notification sound output control device controls a notification sound output device by using the virtual sound source acoustic signal obtained with the virtual acoustic signal processing device so that a notification target person hears the notification sound from a predetermined virtual sound source. In the head-related transfer function storage device, multiple head-related transfer functions are stored to correspond to multiple head shapes of human. The head shape recognition device recognizes a head shape of the notification target person, who is a person to be notified by the predetermined virtual sound source, based on information from a head shape detection device detecting the head shape of the notification target person. The head-related transfer function selection device selects the head-related transfer function corresponding to the recognized head shape from the multiple head-related transfer functions stored in the head-related transfer function storage device based on the head shape recognized by the head shape recognition device.

In the above sound field control apparatus, the multiple head-related transfer functions corresponding to head shapes of various persons are stored in the head-related transfer function storage device (e.g., memory). The head shape of the notification target person is recognized based on the information from the head shape detection device (e.g., a monitor equipped with a camera) which detects the head shape of the notification target person human. The head-related transfer function corresponding to the recognized head shape is selected from the multiple head-related transfer functions stored in the head-related transfer function storage device. That is, in the above sound field control apparatus, the head shape of a driver or the like is recognized based on information acquired from the camera or the like. The head-related transfer function matching the head shape of the driver or the like is selected from the head-related transfer functions stored in the memory or the like. By using the operation using the selected head-related transfer function, the virtual sound source acoustic signal is calculated. By using the virtual sound source acoustic signal, the notification sound is outputted. Therefore, according to the above sound field control apparatus, manual selection and manual adjustment of the head-related transfer function matching each individual driver is not required. Therefore, a remarkably high usability is provided.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a system configuration of a sound field control apparatus according to an embodiment;

FIG. 2 is a diagram illustrating places of cameras;

FIG. 3A is a diagram illustrating feature data of a head front;

FIG. 3B is a diagram illustrating feature data of a head side;

FIG. 4 is a diagram illustrating a head data map that represents a relationship between each feature data and head shape pattern;

FIG. 5 is a diagram illustrating eight base head-related transfer functions;

FIG. 6 is a diagram illustrating a functional configuration of the system;

FIG. 7 is a diagram illustrating a configuration of a filter coefficient generation device;

FIG. 8 is a diagram illustrating a method of synthesizing a head-related transfer function and a crosstalk cancellation filter coefficient;

FIG. 9 is a flowchart illustrating a process for obtaining head shape pattern data; and

FIG. 10 is a flowchart illustrating a process for causing a notification sound to be heard from a virtual sound source.

### DETAILED DESCRIPTION

The sound field control apparatus of one embodiment will be descried with reference to the accompanying drawings.

A system configuration of a vehicle mounted with the sound field control apparatus will be illustrated.

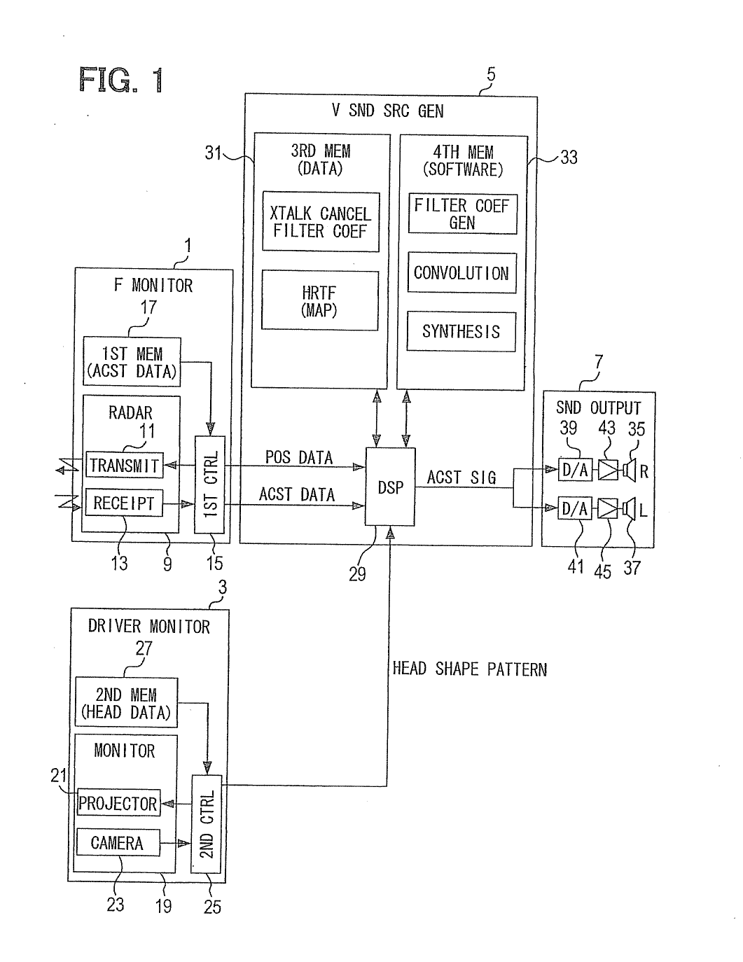

As illustrated in FIG. 1, a system (the sound field control apparatus) for controlling output of notification sound to an occupant (driver) from a virtual sound source includes a front monitor 1, a driver monitor (monitor system) 3, a virtual sound source generation device 5, and a sound output device 7. The front monitor 1 monitors forward of a vehicle. The driver monitor 3 monitors driver's states. The virtual sound source generation device 5 generates a virtual sound source. The sound output device 7 outputs notification sound from the virtual sound source.

The front monitor 1 uses a laser radar 9 to detect an obstacle forward of the vehicle. The laser radar 9 includes a transmission device 11 and a reception device 13. The transmission device 11 outputs a laser beam. The reception device 13 receives a reflected laser beam. The laser radar 9 may be replaced by a CCD camera or a sonar using ultrasonic wave.

The front monitor 1 includes a first controller 15 and first memory 17. The first controller 15 controls operation of the front monitor 1. The first memory 17 stores acoustic data corresponding to the notification sound.

The first controller 13 may be an electronic control unit including a microcomputer and may be integrated with the laser radar 9. The acoustic data may be stored in the virtual sound source generation device 5.

The driver monitor 3 uses a monitor (a head shape detection device) 19 to monitor the driver's head (face) and recognize the head shape. The monitor 19 includes a projector 21 and a camera 23. The projector 21 irradiates near-infrared light to the driver's head. The camera 23 captures the driver's head.

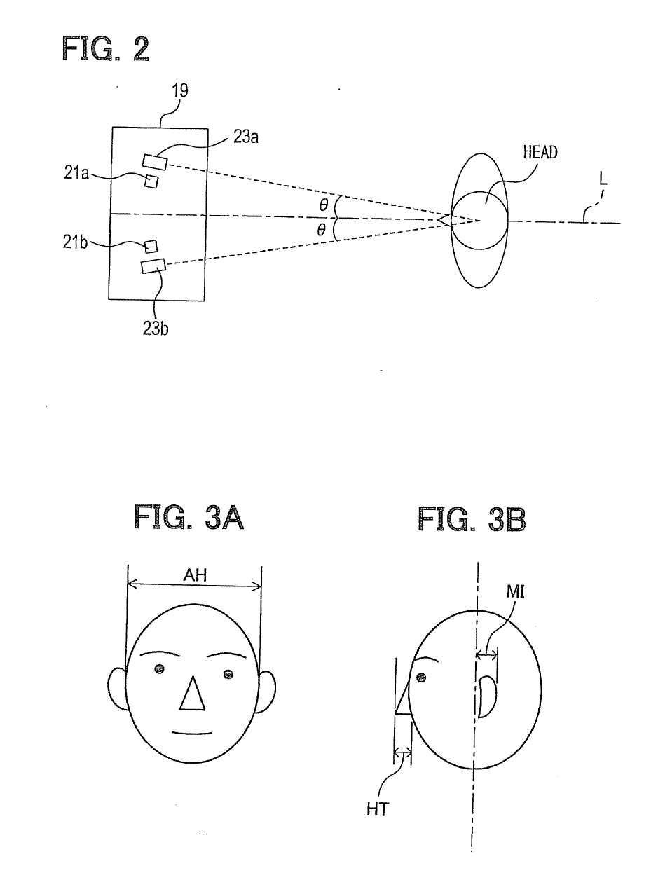

As illustrated in FIG. 2, the camera 23 includes a pair of cameras 23a and 23b to identify a three-dimensional shape of the head. The cameras 23a and 23b are symmetrically placed to form angle θ with reference to a median line (center line L in the horizontal direction of FIG. 2) of the driver or the driver's seat.

The projector 21 includes near-infrared LEDs 21a and 21b which are symmetrically placed to correspond to the cameras 23a and 23b.

In FIG. 1, the driver monitor 3 further includes a second controller 25 and second memory 27. The second controller 25 controls operation of the driver monitor 3. The second memory 27 stores a head data map (described later) used to recognize the head shape.

The second controller 25 may be an electronic control unit including a microcomputer. The head data map may be stored in the virtual sound source generation device 5.

The virtual sound source generation device 5 includes a digital signal processor (DSP) 29, third memory 31, and fourth memory 33. The third memory 31 stores various data such as filter coefficients and the like. The fourth memory 33 stores software and the like.

As will described later, the third memory 31 stores a crosstalk cancellation filter coefficient and a head-related transfer function (HRTF). The fourth memory 33 stores a program for filter coefficient generation, a program for convolution operation, and a program for output synthesis (between a head-related transfer function and a crosstalk cancellation filter coefficient).

The head-related transfer function represents transmission characteristics of the sound from a sound source to an ear. As already known (e.g., see JP 2001-1851A, which is incorporated herein by reference), the head-related transfer function provides a coefficient (for binaural sound source generation) to determine a localization position in listening with right and left ears.

In more detail, in the case of sound generation at an arbitrary position around the head, a sound pressure level changes depending on frequencies until the sound reaches an eardrum via the space, the head, and the ear. The head-related transfer function represents this frequency characteristics in terms of a relative sound pressure level (dB).

The crosstalk cancellation filter coefficient is a filter coefficient for one sound source to be listened with only one ear. That is, the crosstalk cancellation filter coefficient is a filter for eliminating crosstalk from a speaker to the listener's ear.

The sound output device 7 includes a pair of speakers 35 and 37. The sound output device 7 further includes a D/A device 39 and an amplifier 43 in association with the speaker 35, and includes a D/A devices 41 and an amplifier 45 in association with the speaker 37.

In the system, the first controller 15 of the front monitor 1 outputs a positional data of an obstacle and an acoustic data (monaural sound source) of the notification sound to the DSP 29 of the virtual sound source generation device 5.

The second controller 25 of the driver monitor 3 outputs a signal, which includes a data of head shape pattern indicative of the class of the head shape, to the DSP 29.

The DSP 29 selects an optimum head-related transfer function based on the head shape pattern. The DSP 29 executes a program to generate an acoustic signal by using the head-related transfer function and the crosstalk cancellation filter coefficient so that the acoustic signal can provide the virtual sound source. The DSP 29 outputs the acoustic signal to the sound output device 7.

The sound output device 7 outputs a drive signal corresponding to the acoustic signal to the speakers 35 and 37. The speakers 35 and 37 thereby operate, so that an occupant hears the notification sound from the localization position of the virtual sound source.

Next, operations and their principle will be specifically illustrated.

In the embodiment, the driver's head shape is recognized based on images taken with the cameras 23a and 23b, and a head-related transfer function corresponding to the head shape is selected. The laser radar 9 detects the position of an obstacle (object such as a preceding vehicle or the like) ahead of the vehicle. The virtual sound source is provided at the position of the obstacle (based on the selected head-related transfer function) and is controlled so that the driver can hear the notification sound from the virtual sound source.

An audio image localization using the head-related transfer function will be described.

The head-related transfer function has different values depending on head and ear shapes and installation positions (angles) of the sound sources. It is considered that a reason why a human can identify the sound source position is that the human has a grasp of his or her head-related transfer function and its dependency on angles.

Thus, by controlling frequency characteristics of the sound that reaches the right and left eardrums, it is possible to arbitrarily change directions in which the sound can be heard.

As described later, the use of the head-related transfer function can position (localize) an audio image at arbitrary position and provide the virtual sound source at any position. A notification sound (e.g., alarm sound) can be heard from the localization position of the virtual sound source if an acoustic signal acquired from the head-related transfer function is outputted from the speaker.

A method of selecting the head-related transfer function corresponding to a head shape will be described.

As described above, the head-related transfer function varies with head shapes. In the present embodiment, the cameras 23a and 23b are used to identify a three-dimensional shape of the head, and multiple head-related transfer functions are selected according to the identified head shape.

Specifically, a pair of cameras 23a and 23b is placed apart from each other to the right and the left with reference to a driver. Directions (parallaxes) of the cameras 23a and 23b are used to detect a three-dimensional shape by two images (stereo measurement method).

The stereo measurement method includes preliminary calibration to calculate and obtain internal parameters of the right and left cameras 23a and 23b and a positional relationship between the cameras 23a and 23b. After the calibration, the method accurately calculates a three-dimensional shape of the object based on a difference between visions (i.e., images) of the cameras 23a and 23b.

For a technique of a three-dimensional shape using the two cameras (3D cameras), see JP H6-180218A and JP 2006-258543A, which are incorporated herein by reference.

A three-dimensional shape may be specified by using other technologies. For example, a laser beam may be irradiated to the driver's head. A camera captures the head with the reflected light. A three-dimensional shape may be recognized from the captured image (e.g., see JP 2005-30774A, which is incorporated herein by reference).

A manner of setting the head-related transfer function according to a head shape will be described.

As shown in FIGS. 3A and 3B, head shape parameters (feature data) which may affect the head-related transfer function are set. Specifically, the feature data including a head width (AH), a nose height (HT), and an ear position (MI) in a front-back direction of the head is set. The ear position may be represented by the position of the rear end of the ear with respect to the head center.

The other feature data may be employed such as the curvature at a given position of the head, the ear width (horizontal size from the face), and the ear area (viewed from the front).

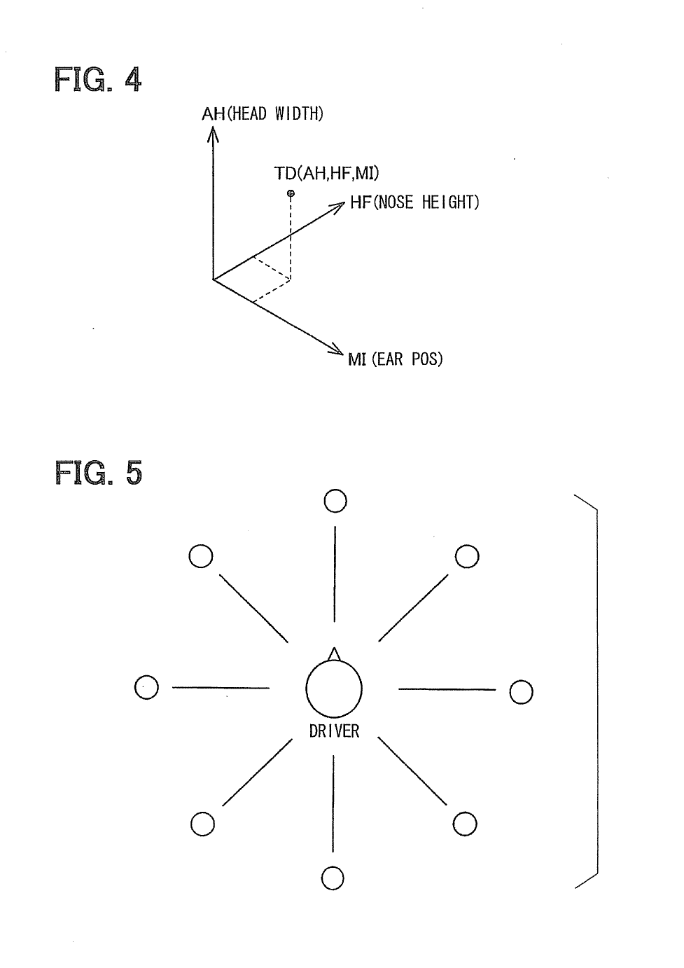

As shown in FIG. 4, head shape patterns (TD) corresponding to different head width, different nose height, and different ear position are set to constitute a head data map. In other words, each of the head width, the nose height, and the ear position is classified according to predetermined size, and the head shape patterns are set based on this classification. Therefore, once the head width, the nose height, and the ear position of a head are acquire, the head shape pattern corresponding to the head can be specified.

Additionally, an experiment is conducted to create head models by adding different head width values, different nose height values, and different ear position values to a standard head model and obtain head-related transfer functions of the created head models.

In this way, a head-related transfer function is set for each head shape pattern. The third memory 31 stores data (shape-function map) indicating relationship between the head shape pattern and the head-related transfer function.

In the present embodiment, for preparation for the below-described interpolation process, head-related transfer functions corresponding to the presence of eight sound sources at specified distances from the driver in eight directions are obtained for each head shape pattern as illustrated in FIG. 5, instated of a head-related transfer function corresponding to a single localization position of the virtual sound source.

Thus, in the shape-function map, the eight head-related transfer functions (i.e., a head-related transfer function group) are set to correspond to each head shape pattern.

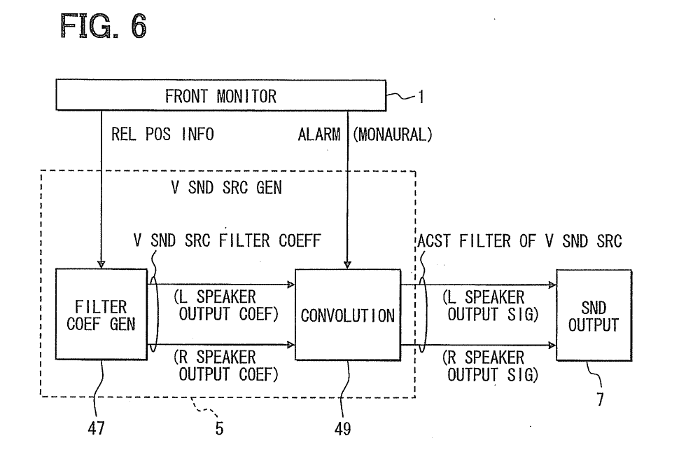

A method of generating a base virtual sound source will be described. As shown in a function block diagram in FIG. 6, a filter coefficient generation device 47 of the virtual sound source generation device 5 acquires position data (information about a relative position between the vehicle and an object) from the front monitor 1. The filter coefficient generation device 47 generates filter coefficients (virtual sound source filter coefficients) based on the position data. The virtual sound source filter coefficients include a coefficient for right speaker output and a coefficient for left speaker output.

A convolution operation device 49 performs a convolution operation. That is, in time domain, the convolution operation device 49 convolutes the virtual sound source filter coefficient into a notification sound (monaural sound source) acquired from the front monitor 1.

Other operations may be employed if they can implement the same function as the convolution. For example, by the fast Fourier transform (FFT), the acoustic data and the virtual sound source filter coefficient are transformed into frequency domain data, and these two frequency domain data are complex-multiplied. The inverse FFT is then performed to acquire the same result as the convolution operation in time domain.

A 2-channel acoustic signal (corresponding to the right and left speakers 35 and 37) obtained by the convolution operation is played and outputted by the right and left speakers 35 and 37, so that the virtual sound source is provided at an intended localization position.

The filter coefficient generation device 47 is a functional block of the virtual sound source generation device 5 that generates the virtual sound source filter coefficient. The convolution operation device 49 is a functional block of the virtual sound source generation device 5 that performs the convolution operation.

(4) The process in the filter coefficient generation device 47 will be more specifically described.

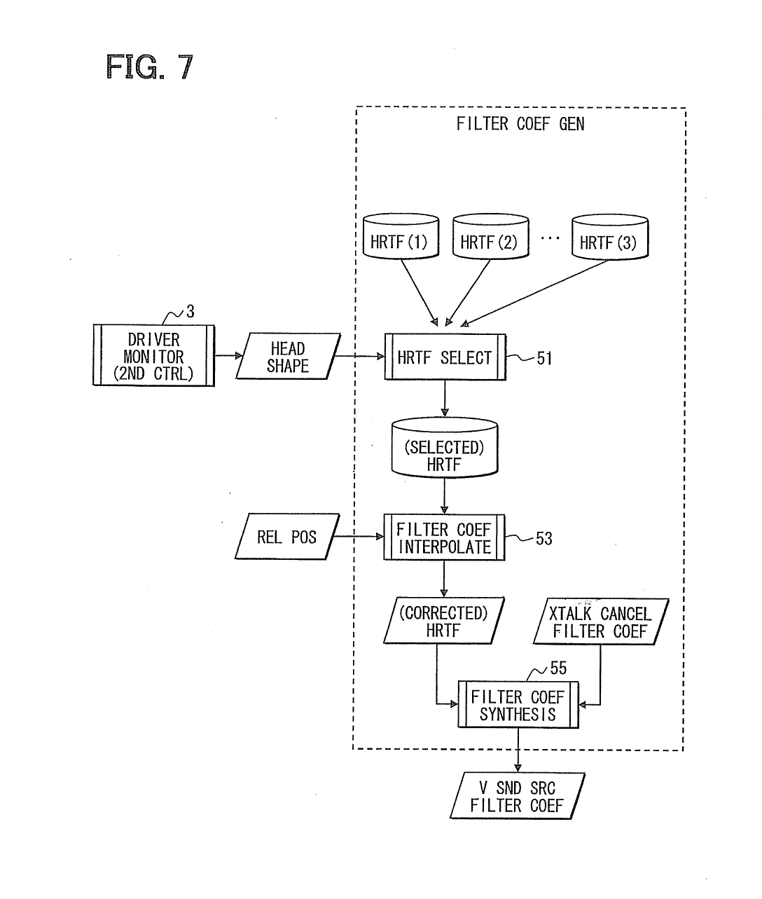

As illustrated in FIG. 7, an HRTF selection device 51 of the filter coefficient generation device 47 references the shape-function map stored in the third memory 31 based on the data of head shape pattern (head shape pattern data), wherein the data of head shape pattern is acquired from the driver monitor 3 and indicates the head shape. The HRTF selection device 51 selects, as base head-related transfer functions, head-related transfer functions most suitable for the head shape, that is, the HRTF selection device 51 selects the head-related transfer functions that can achieve a most accurate localization or the like by the virtual sound source.

A specified number (n) of head-related transfer functions (HRTF[1], HRTF[2], . . . , and HRTF[n]) corresponding to each head shape pattern (TD, see FIG. 4) is stored in the shape-function map. These head-related transfer functions (HRTF[1], HRTF[2], . . . , and HRTF[n]) are associated with the above-described situation (see FIG. 5) where the sound sources are present around the driver and located at specified distances from the driver in eight directions.

Next, a filter coefficient interpolation device 53 interpolates a filter coefficient using the eight base head-related transfer functions (the selected head-related transfer functions).

Specifically, since it is impossible to retain (store) all of head-related transfer functions concerning all localization positions in the space around the driver, a head-related transfer function corresponding to a relative position of the object is obtained by performing the interpolation using the eight base head-related transfer functions.

For example, when the head-related transfer functions of 30 and 70 degrees to the right with reference to the front of the driver are stored, a head-related transfer function of 50 degrees to the right with reference to the front of the driver is generated by the interpolation so that a sound pressure variation state becomes intermediate (e.g., proportionally distributed) between 30 and 70 degrees to the right.

Next, a filter coefficient synthesis device 55 synthesizes the head-related transfer function (obtained after the interpolation) and the crosstalk cancellation filter coefficient to generate a virtual sound source filter coefficient.

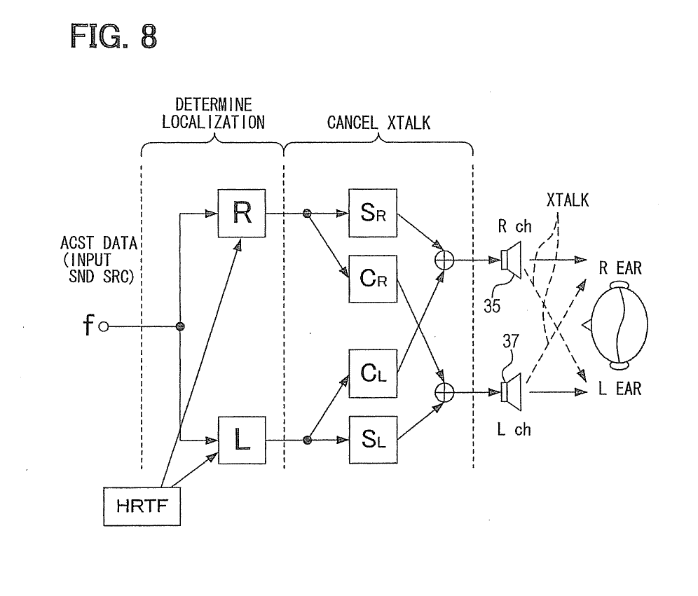

Specifically, as illustrated in FIG. 8, the filter coefficient synthesis device 55 performs calculation on the head-related transfer functions R and L (after the interpolation) corresponding to the right and left ears for determining the localization position and crosstalk cancellation filter coefficients S_{R}, C_{R}, C_{L}, and S_{L} for canceling a crosstalk, thereby obtaining a virtual sound source filter coefficients (R×Sₙ+L×C_{L}) and a virtual sound source filter coefficients (L×S_{L}+R×C_{R}). The filter coefficient synthesis device 55 outputs acoustic signals corresponding to the speakers 35 and 37.

Specifically, the filter coefficient synthesis device 55 performs the calculation with the following equations (1) and (2) to obtain the outputs corresponding to the right and left speakers 35 and 37. In Equations (1) and (2), the symbol “×” denotes the convolution operation.

Right speaker output=(R×Sₙ+L×C_{L})×f (1)

Left speaker output=(L×S_{L}+R×C_{R})×f (2)

where:

S_{R} is a coefficient for transmitting the sound entering the right ear from the right speaker;

C_{R} is a coefficient for canceling the sound entering the right ear from the left speaker;

C_{L} is a coefficient for canceling the sound entering the left ear from the right speaker;

S_{L} is a coefficient for transmitting the sound entering the left ear from the left speaker; and

f is a acoustic data (input sound source)

Specifically, as illustrated in FIG. 6 and equations (1) and (2), the convolution operation device 49 convolutes the virtual sound source filter coefficients, which are generated by the filter coefficient generation device 47, with the notification sound acoustic data and generates the acoustic signals of the virtual sound source corresponding to the right and left speakers 35 and 37.

The speakers 35 and 37 are driven based on the acoustic signals to generate the sound, so that the driver hears the notification sound (e.g., electronic sound) from the position where the object exists.

The processes according to the embodiment will be described.

<Process to Obtain Head Shape Pattern Data>

This process is performed by the second controller 25.

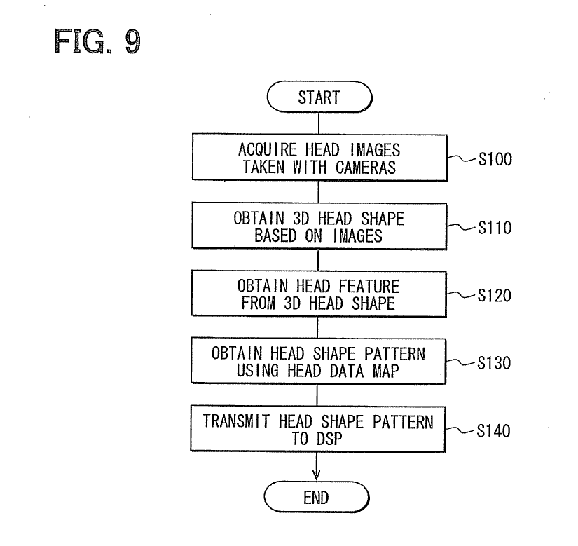

At S100 as illustrated in FIG. 9, the second controller 25 instructs the cameras 23a and 23b to photograph the head and acquires images of the head.

At S110, the second controller 25 obtains a three-dimensional shape of the head based on the images acquired from the cameras 23a and 23b.

At S120, the second controller 25 obtains the feature data including the head width (excluding ears), the nose height, and the ear position in the front-back direction of the head from the three-dimensional shape of the head.

At S130, the second controller 25 references the head data map and specifies a head shape pattern (into which the head shape is classified) from the feature data.

At S140, the second controller 25 transmits a data of the head shape pattern to the DSP 29 and terminates the process.

<Process for the Notification Sound to be Heard from the Virtual Sound Source>

This process is performed by the DSP 29.

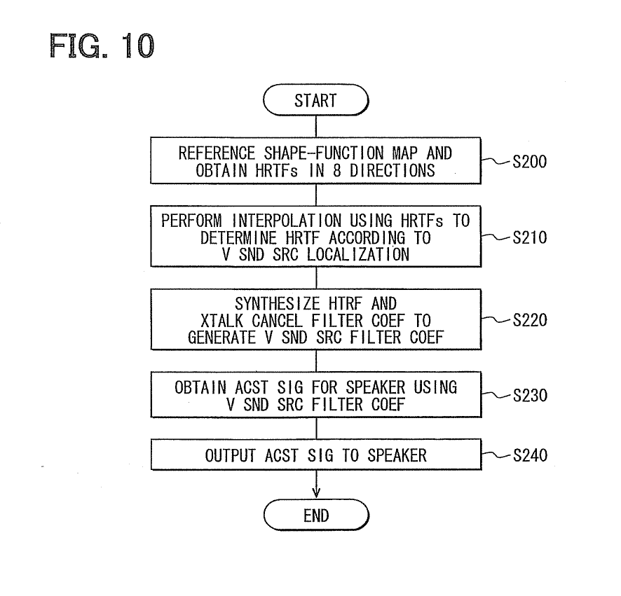

At S200 as illustrated in FIG. 10, the DSP 29 references the shape-function map based on the head shape pattern acquired from the driver monitor 3 and retrieves the corresponding head-related transfer functions in eight directions.

At S210, the DSP 29 performs the above-mentioned interpolation by using the head-related transfer functions in eight directions based on positional data such as a positional data of an obstacle acquired from the front monitor 1 and determines a head-related transfer function corresponding to the localization position of the targeted virtual sound source.

At S220, the DSP 29 synthesizes the interpolated head-related transfer function and the crosstalk cancellation filter coefficient to generate a virtual sound source filter coefficient.

At S230, the DSP 29 obtains an acoustic signal output to the speakers 35 and 37 by using the virtual sound source filter coefficient.

At S240, the DSP 29 outputs the acoustic signal to the speakers 35 and 37 to generate a notification sound so that the notification sound is heard from the localization position of the virtual sound source. After S240, the process illustrated in FIG. 10 is ended.

Technical effects of the present embodiment will be illustrated.

In the present embodiment, the driver's head shape is recognized based on image information acquired from the cameras 23a and 23b. A head-related transfer function corresponding to the head shape is selected from the head-related transfer functions stored in the third memory 31. A virtual sound source acoustic signal is calculated using the head-related transfer function. A notification sound is outputted using the virtual sound source acoustic signal.

Therefore, as opposed to the conventional technology, the present embodiment can eliminate the need for the manual selection of a head-related transfer function matching each individual driver and can provide high usability.

Moreover, in the present embodiment, since a three-dimensional shape of the driver's head is detected, it is possible to recognize the head shape in a detailed manner. Therefore, it is possible to select an appropriate head-related transfer function.

In the present embodiment, the head shapes are classified into multiple head shape patterns, so that the head shape is recognized based on three-dimensional data indicating the three-dimensional head shape. Therefore, once the head-related transfer functions are set in association with the head shape patterns, it becomes possible to easily select a head-related transfer function that matches arbitrary head shape.

Specifically, in the present embodiment, since the head-related transfer functions are stored in the third memory 31 to correspond to the head shape patterns, it is possible to easily select the corresponding head-related transfer function by designating a head shape pattern (head shape).

In addition, in the present embodiment, since the head shape pattern is specified by using multiple feature data each indicating a head shape feature, it is possible to easily specify the head shape pattern once the feature data are acquired.

In the present embodiment, for each head shape pattern, two or more head-related transfer functions corresponding to two or more localization positions of the virtual sound sources around the head is stored. Therefore, by performing the interpolation using the two or more head-related transfer functions, it is possible to obtain a head-related transfer function that corresponds to arbitrary position.

Embodiments are not limited to the above illustrated embodiment. Embodiments can be various forms within the spirit and scope of the present disclosure.

(1) For example, instead of acquisition of the head shape as a three-dimensional shape, the head shape may be estimated from a two-dimensional image taken with a single camera.

In this case, for example, the head width, the ear area (viewed from the front), and the ear height may be used as feature data, and a head shape pattern may be set so as to correspond to the feature data.

(2) Alternatively, a three-dimensional shape may be estimated from two-dimensional data.

(3) A stereo dipole system (e.g., see Japanese Unexamined Patent Application Publication (Translation of PCT Application) No. 2000-506691, which is incorporated by reference) may be used to generate a virtual sound source.

(4) An computer executable program for causing a computer to execute processes illustrated in FIGS. 9 and 10 is also an embodiment of the present disclosure. Such a computer executable program may be stored in a non-transitory tangible computer readable storage medium Namely, the above-mentioned functions of the sound field control apparatus may be implemented by the computer program.

In the above embodiment, the DSP 29 performing S230 can correspond to an example of a virtual acoustic signal processing device or means. The DSP 29 performing S240 can correspond to an example of a virtual acoustic signal processing device or means. The sound output device 7 can correspond to an example of notification sound output device or means. The third memory 31 can correspond to an example of head-related transfer function storage device or means. The HRTF selection device 51 can correspond to an example of head-related transfer function selection device or means. The monitor 19 can correspond to an example of head shape detection device or means. The camera 23 can correspond to an example of imaging device or imaging means. The front monitor 1 can correspond to an example of obstacle monitor or obstacle monitoring means.

According to an example of the present disclosure, a sound field control apparatus comprises a virtual acoustic signal processing device, a notification sound output control device, a head-related transfer function storage device, a head shape recognition device, a head shape recognition device, and a head-related transfer function selection device. The virtual acoustic signal processing device obtains a virtual sound source acoustic signal by performing an operation using an acoustic data of a notification sound and a head-related transfer function. The notification sound output control device controls a notification sound output device by using the virtual sound source acoustic signal obtained with the virtual acoustic signal processing device so that a notification target person hears the notification sound from a predetermined virtual sound source. In the head-related transfer function storage device, multiple head-related transfer functions are stored to correspond to multiple head shapes of human. The head shape recognition device recognizes a head shape of the notification target person, who is a person to be notified by the predetermined virtual sound source, based on information from a head shape detection device detecting the head shape of the notification target person. The head-related transfer function selection device selects the head-related transfer function corresponding to the recognized head shape from the multiple head-related transfer functions stored in the head-related transfer function storage device based on the head shape recognized by the head shape recognition device.

In the above sound field control apparatus, the multiple head-related transfer functions corresponding to head shapes of various persons are stored in the head-related transfer function storage device (e.g., memory). The head shape of the notification target person is recognized based on the information from the head shape detection device (e.g., a monitor equipped with a camera) which detects the head shape of the notification target person. The head-related transfer function corresponding to the recognized head shape is selected from the multiple head-related transfer functions stored in the head-related transfer function storage device.

That is, in the above sound field control apparatus, the head shape of a driver or the like is recognized based on information acquired from the camera or the like. The head-related transfer function matching the head shape of the driver or the like is selected from the head-related transfer functions stored in the memory or the like. By using the operation using the selected head-related transfer function, the virtual sound source acoustic signal is calculated. By using the virtual sound source acoustic signal, the notification sound is outputted.

According to the above sound field control apparatus, manual selection and manual adjustment of the head-related transfer function matching each individual driver is not required. Therefore, a remarkably high usability is provided.

The above sound field control apparatus may be configured as follows. The head shape detection device includes an imaging device that detects one of a three-dimensional head shape and a two-dimensional head shape of the notification target person. According to this configuration, it is possible to select an appropriate head-related transfer function.

The above sound field control apparatus may be configured as follows. By using classification of head shapes into multiple head shape patterns, the head shape recognition device recognizes the head shape based on one of three-dimensional data representing the three-dimensional head shape and two-dimensional data representing the two-dimensional head shape.

According to the above configuration, by using classification of head shapes into multiple head shape patterns, the head shape is recognized based on the three-dimensional head shape or the two-dimensional head shape. Therefore, by association of the head-related transfer functions with the head shape patterns, the head-related transfer function appropriate matching the head shape can be easily selected.

The above sound field control apparatus may be configured as follows. Each head shape pattern is specified using one or more feature data each representing a head feature. This is an example of a manner of specifying a head shape pattern.

For example, a head width, a nose height, an ear position in a front-back direction of the head, or the like may be set as the feature data representing features of the head shape. In this case, the head shape patterns corresponding to these feature data may be preset, so that the head shape pattern can be determined from the feature data.

The feature data can include various data indicative of the head shape (which can affect the head-related transfer function). For example, the feature data can include a curvature at a given position (e.g., face) of a head, an ear width, an ear area or the like.

The above sound field control apparatus may be configured as follows. The head-related transfer function storage device stores the multiple head-related transfer functions so that at least one head-related transfer function is associated with each of the head shape patterns. According to this configuration, the head-related transfer functions are stored to correspond to the head shape pattern respectively. Therefore, by designating a head shape pattern, it is possible to obtain the corresponding head-related transfer function.

The above sound field control apparatus may be configured as follows. The at least one head-related transfer function associated with each of the head shape patterns are two or more one head-related transfer functions which respectively correspond to two or more localization positions of the virtual sound sources around the head.

According to the above configuration, the two or more head-related transfer functions respectively corresponding to two or more localization positions of the virtual sound source around the head are stored for a corresponding head shape pattern. Therefore, by using the two or more head-related transfer functions (e.g., interpolation), it is possible to obtain a head-related transfer function corresponding to arbitrary position.

Processes performed by a computer program can implement the above-mentioned functions of the sound field control apparatus.

Such a program can be stored in a non-transitory tangible computer-readable storage medium such as FD, MO, DVD-ROM, CD-ROM, and hard disk, for example, and can be loaded to the computer as necessary to be started and used. Alternatively, the program may be stored in ROM or backup RAM as a non-transitory tangible computer-readable storage medium, and the ROM or backup RAM may be installed in the computer.

The above sound field control apparatus may further comprise a filter coefficient generation device, a convolution operation device, and a virtual sound source output device. The filter coefficient generation device generates a virtual sound source filter coefficient according to a localization position of the virtual sound source. The convolution operation device convolutes the acoustic data of the notification sound with the virtual sound source filter coefficient and output the virtual sound source acoustic signal. The virtual sound source output device allows the notification sound output device to output and reproduce the virtual sound source acoustic signal.

The above sound field control apparatus may be applied to a vehicle. The head shape recognition device may automatically recognize the head shape of a driver of a vehicle based on the image of the head shape of the driver taken with a camera in the vehicle. The head-related transfer function selection device may retrieve the two or more head-related transfer functions corresponding to the recognized head shape of the driver of the vehicle from the multiple head-related transfer functions stored in the head-related transfer function storage device, and may perform interpolation by using the retrieved two or more head-related transfer functions, thereby obtaining a target head-related transfer function that corresponds to a position of an obstacle around the vehicle detected with an obstacle monitor. The virtual acoustic signal processing device may obtain the virtual sound source acoustic signal based on the acoustic data of the notification sound and the target head-related transfer function obtained by the head-related transfer function selection device. The notification sound output control device may control the notification sound output device by using the virtual sound source acoustic signal obtained with the virtual acoustic signal processing device so that the driver hears the notification sound from the predetermined virtual sound source whose localization position corresponds to the position of the obstacle detected with the obstacle monitor.

The filter coefficient generation device may interpolate predetermined virtual sound source filter coefficients to obtain the virtual sound source filter coefficient corresponding to the target localization position of the virtual sound source. In this case, the predetermined virtual sound source filter coefficient may be a head-related transfer functions or a synthesis of a head-related transfer function and a crosstalk cancellation filter coefficient.

The present disclosure is not limited the above embodiments and modifications thereof. That is, the above embodiments and modifications thereof may be modified in various ways without departing from the sprit and scope of the present disclosure.

What is claimed is:

1. A sound field control apparatus comprising:
a virtual acoustic signal processing device that obtains a virtual sound source acoustic signal by performing an operation using an acoustic data of a notification sound and a head-related transfer function;
a notification sound output control device that controls a notification sound output device by using the virtual sound source acoustic signal obtained with the virtual acoustic signal processing device so that a notification target person hears the notification sound from a predetermined virtual sound source;
a head-related transfer function storage device in which a plurality of head-related transfer functions is stored to correspond to a plurality of head shapes of human;
a head shape recognition device that recognizes a head shape of the notification target person, who is a person to be notified by the predetermined virtual sound source, based on information from a head shape detection device detecting the head shape of the notification target person; and
a head-related transfer function selection device that selects the head-related transfer function corresponding to the recognized head shape from the plurality of head-related transfer functions stored in the head-related transfer function storage device based on the head shape recognized by the head shape recognition device.

2. The sound field control apparatus according to claim 1, wherein:
the head shape detection device includes an imaging device that detects one of a three-dimensional head shape and a two-dimensional head shape of the notification target person.

3. The sound field control apparatus according to claim 1, wherein:
by using classification of head shapes into a plurality of head shape patterns, the head shape recognition device recognizes the head shape based on one of three-dimensional data representing the three-dimensional head shape and two-dimensional data representing the two-dimensional head shape.

4. The sound field control apparatus according to claim 3, wherein
each head shape pattern is specified using one or more feature data each representing a head feature.

5. The sound field control apparatus according to any one of claim 1, wherein:
the head-related transfer function storage device stores the plurality of head-related transfer functions so that at least one head-related transfer function is associated with each of the head shape patterns.

6. The sound field control apparatus according to claim 5, wherein:
the at least one head-related transfer function associated with each of the head shape patterns are two or more one head-related transfer functions which respectively correspond to two or more localization positions of the virtual sound source around the head.

7. A non-transitory tangible computer readable storage medium storing a computer-executable program that causes a computer to function as the head shape recognition device and the head-related transfer function selection device of the sound field control apparatus recited in claim 1.

8. The sound field control apparatus according to claim 5, wherein:
the head shape recognition device automatically recognizes the head shape of a driver of a vehicle based on the image of the head shape of the driver taken with a camera in the vehicle;
the head-related transfer function selection device retrieves the two or more head-related transfer functions corresponding to the recognized head shape of the driver of the vehicle from the plurality of head-related transfer functions stored in the head-related transfer function storage device, and performs interpolation by using the retrieved two or more head-related transfer functions, thereby obtaining a target head-related transfer function that corresponds to a position of an obstacle around the vehicle detected with an obstacle monitor;
the virtual acoustic signal processing device obtains the virtual sound source acoustic signal based on the acoustic data of the notification sound and the target head-related transfer function obtained by the head-related transfer function selection device; and
the notification sound output control device controls the notification sound output device by using the virtual sound source acoustic signal obtained with the virtual acoustic signal processing device so that the driver hears the notification sound from the predetermined virtual sound source whose localization position corresponds to the position of the obstacle detected with the obstacle monitor.
